(19) United States
(12) Patent Application Publication
(10) Pub. No.: US 2022/0338539 A1
(43) Pub. Date: Oct. 27, 2022

(54) Atomizing Element of A Portable Evaporator Made of Consolidated Glassy Nanoparticles

(71) Applicant: Joseph Schlaegel, Sacramento, CA (US)

(72) Inventor: Joseph Schlaegel, Sacramento, CA (US)

(21) Appl. No.: 17/242,023

(22) Filed: Apr. 27, 2021

(51) Int. Cl. A24F 40/46; A24F 40/44; A24F 40/10; H05B 3/42

(52) U.S. Cl. CPC A24F 40/46; A24F 40/44; A24F 40/10; H05B 3/42

(57) ABSTRACT

An atomizing module of an evaporator, the module including: an end cover; a seal ring; a meshed heating disc; an e-liquid conducting cotton including a surface; and a support. The e-liquid conducting cotton is loaded on the support. The meshed heating disc is disposed on the surface of the e-liquid conducting cotton. The meshed heating disc is made of silica-glass material prepared by consolidation of glassy nanoparticles. The end cover is embedded in the support, which facilitates the cooperation of the meshed heating disc and the e-liquid conducting cotton. The seal ring is disposed on the end cover.

Referenced Cited U.S. Patent Documents

| | | |
|---|---|---|
| 20160235121 | Aug. 18, 2016 | Rogan |
| 20160309785 | Oct. 27, 2016 | Holtz |
| 20180213845 | Aug. 2, 2018 | Qiu |

### FIELD OF THE INVENTION

The invention relates to an atomizing module of a portable evaporator.

### DESCRIPTION OF THE RELATED ART

An atomizing module of an evaporator includes a heating coil, e-liquid conducting cotton, and a fixed seat for fixing the heating coil. The contact area between the heating coil and the e-liquid conducting cotton is relatively small, so the heating is uneven which leads to poor atomizing of the e-liquid.

### SUMMARY OF THE INVENTION

In view of the above-described problems, it is one objective of the invention to provide an atomizing module of an evaporator that heats the e-liquid more evenly.

To achieve the above objectives, in accordance with one embodiment of the invention, there is provided an atomizing module of an evaporator, the module comprising: an end cover; a seal ring; a meshed heating disc; an e-liquid conducting cotton comprising a surface; and a support. The e-liquid conducting cotton is loaded on the support; the meshed heating disc is disposed on the surface of the e-liquid conducting cotton; the end cover is embedded in the support to facilitate the cooperation of the meshed heating disc and the e-liquid conducting cotton; and the seal ring is disposed on the end cover.

The e-liquid conducting cotton is linen cotton in the shape of a circle. The linen cotton has better high temperature resistance and stability than common cotton, thus extending the service life of the atomizing module. The heating disc is uniformly disposed on the surface of the e-liquid conducting cotton, which increases the contact area of the two components, thus achieving the even heating and better atomizing effect. The seal ring is disposed on the end cover, increasing the sealing property of the atomizing module. Thus, when the atomizing module cooperates with other elements such as holder, metal sleeve, battery pack and the like, the entire an evaporator presents better sealing properties.

In a class of this embodiment, the meshed heating disc is made of iron-chromium metal material and comprises eight concentric circles, and every two concentric circles are connected by three connecting points; the eight concentric circles comprise an outermost circle and an innermost circle; the outermost circle is connected to a negative pole of a power supply, and the innermost circle is connected to a positive pole of the power supply. When the atomizing module is electrified, the current generated from the positive connection piece flows from the inner ring to the outer ring of the heating disc and converges at the negative pole to yield heat energy.

In another class of this embodiment, the meshed heating disc is made of silica-glass material prepared by consolidation of glassy nanoparticles; silica-glass prepared by consolidation of glassy nanoparticles exhibits remarkable tensile ductility. Because of dangling bonds at surfaces and high contact stresses, the pressure applied for consolidating glassy nanoparticles to achieve ductility is significantly lower than that required to toughen bulk glass via permanent densification. We have identified 5-fold silicon, with a higher propensity to carry out local shear deformation than 4-fold silicon, as the structural origin for the observed tensile ductility. Interestingly, the work hardening effect has been, for the first time, observed in thus-prepared silica glass, with its strength increasing from 4 GPa to ˜7 GPa upon cold work. This is due to stress-assisted relaxation of 5-fold silicon to 4-fold during cold work, analogous to transformation hardening. The shape of the meshed heated disc comprises an outermost circle and an innermost circle; the outermost circle is connected to a negative pole of a power supply, and the innermost circle is connected to a positive pole of the power supply. When the atomizing module is electrified, the current generated from the positive connection piece flows from the inner ring to the outer ring of the heating disc and converges at the negative pole to yield heat energy.

The meshed heating disc, the support, the e-liquid conducting cotton and the end cover form an integrated atomizing module, so it is easy to replace in case of failure.

Advantages of the atomizing module of an evaporator of the disclosure are summarized as follows. The atomizing module of the disclosure is an integrated structure, so it is easy to replace in case of failure. The e-liquid conducting cotton employs linen cotton which has better high temperature resistance and stability, thus prolonging the service life of the atomizing module. The heating disc is uniformly disposed on the surface of the e-liquid conducting cotton, so the heating is even, improving the atomizing effect.

### BRIEF DESCRIPTION OF THE DRAWINGS

The invention is described herein below with reference to the accompanying drawings, in which:

FIG. 1 is a general view of an atomizing module of an evaporator in accordance with one embodiment of the disclosure;

FIG. 2 is a cross-sectional view of a meshed heating disc of an atomizing module of an evaporator in accordance with one embodiment of the disclosure;

FIG. 3 is a slanted view of an atomizing module of an evaporator in accordance with one embodiment of the disclosure; and

FIG. 4 is a sectional view of an atomizing module of an evaporator in accordance with one embodiment of the disclosure.

### DETAILED DESCRIPTION OF THE DRAWINGS

For further illustrating the invention, experiments detailing an atomizing module of an evaporator are described below.

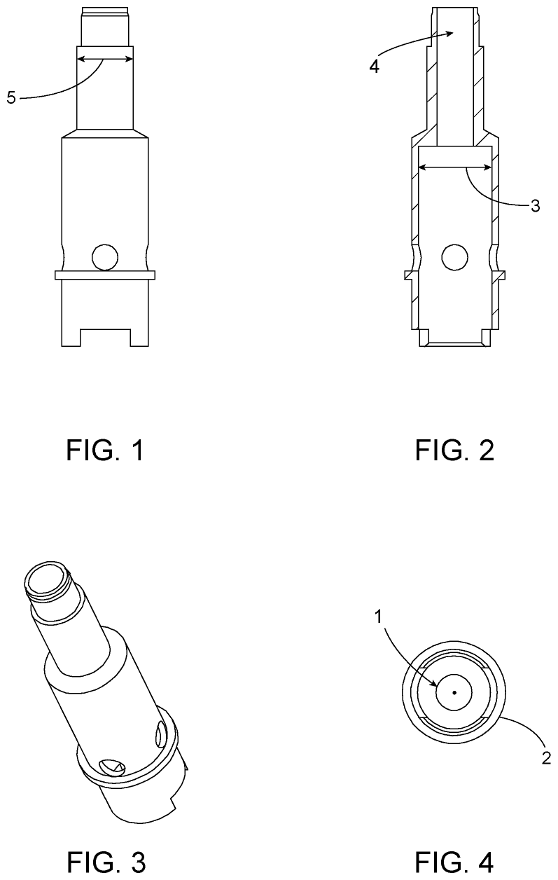

As shown in FIGS. 1-4, an atomizing module of an evaporator comprises an end cover 1; a seal ring 2; a meshed heating disc 3; an e-liquid conducting cotton 4 comprising a surface; and a support. The e-liquid conducting cotton 4 is loaded on the support 5. The meshed heating disc 3 is disposed on the surface of the e-liquid conducting cotton 4. The end cover 1 is embedded in the support 5, which facilitates the cooperation of the meshed heating disc 3 and the e-liquid conducting cotton 4. The seal ring 2 is disposed on the end cover.

The e-liquid conducting cotton 4 is linen cotton in the shape of a circle. The linen cotton has better high temperature resistance and stability than common cotton, so the e-liquid carrying capacity is improved. The heating disc disposed on the surface of the e-liquid conducting cotton, which increases the contact area of the two components, thus achieving the even heating and better atomizing effect. The seal ring 2 is disposed on the end cover, increasing the sealing property of the atomizing module. Thus, when the atomizing module cooperates with other elements such as cigarette holder, metal sleeve, battery pack and the like, the entire an evaporator presents better sealing properties.

The meshed heating disc 3 is made of iron-chromium metal material and comprises eight concentric circles, or the meshed heating disc is made of silica-glass material prepared by consolidation of glassy nanoparticles, where every two concentric circles are connected by three connecting points, an outermost circle of the eight concentric circles is connected to a negative pole of a power supply, and an innermost circle of the eight concentric circles is connected to a positive pole of the power supply. When the atomizing module is electrified, the current generated from the positive connection piece flows from the inner ring to the outer ring of the heating disc and converges at the negative pole to yield heat energy.

The meshed heating disc, the support, the e-liquid conducting cotton and the end cover form an integrated atomizing module, which is conducive to replace when it is broken down. The e-liquid conducting cotton employs linen cotton which has better high temperature resistance and stability, thus prolonging the service life of the atomizing module. The heating disc is uniformly disposed on the surface of the e-liquid conducting cotton, so the heating is even, improving the atomizing effect.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. An atomizing module of an evaporator, the module comprising:
an end cover;
a seal ring;
a meshed heating unit comprising a heating surface;
an e-liquid conducting cotton comprising a top surface; and
a support comprising a supporting surface and a sidewall; wherein the e-liquid conducting cotton is disposed on the supporting surface;
the meshed heating unit is disposed on the top surface of the e-liquid conducting cotton and the heating surface abuts against the top surface;
the meshed heating disc is made of silica-glass material prepared by consolidation of glassy nanoparticles
the meshed heating unit and the e-liquid conducting cotton are coaxially disposed around a central axis;
the end cover is disposed on the sidewall of the support;
the seal ring is disposed on the end cover;
a distance between the heating surface and the supporting surface increases along a radial direction away from the central axis; and
a distance between the top surface and the supporting surface increases along the radial direction away from the central axis.

2. The module of claim 1, wherein the meshed heating unit is made of iron-chromium metal material and comprises eight concentric circles, and every two concentric circles are connected by three connecting points; the eight concentric circles comprise an outermost circle and an innermost circle; the outermost circle is connected to a negative pole of a power supply, and the innermost circle is connected to a positive pole of the power supply.

3. The module of claim 2, wherein the e-liquid conducting cotton is linen cotton in the shape of a circle.

4. The module of claim 1, wherein the e-liquid conducting cotton is linen cotton in the shape of a circle.
